(19) United States
(12) Patent Application Publication
(10) Pub. No.: US 2013/0182826 A1
(43) Pub. Date: Jul. 18, 2013

(54) RADIATION GENERATING APPARATUS AND RADIOGRAPHIC APPARATUS

(71) Applicant: CANON KABUSHIKI KAISHA, Tokyo (JP)

(72) Inventors: Kazuyuki Ueda, Tokyo (JP); Koji Yamazaki, Ayase-shi (JP)

(73) Assignee: CANON KABUSHIKI KAISHA, Tokyo (JP)

(21) Appl. No.: 13/741,754

(22) Filed: Jan. 15, 2013

(30) Foreign Application Priority Data
Jan. 17, 2012 (JP) 2012-006953

(51) Int. Cl. H01J 35/02

(52) U.S. Cl. CPC H01J 35/02
USPC 378/141

(57) ABSTRACT

Radiation generating apparatus includes an envelope and a radiation tube disposed inside the envelop. A cooler is connected to the envelope at an inlet port and an outlet port. Coolant circulates between the cooler and the envelope through the inlet port and outlet port. A partition plate divides the inside of the envelope into a first chamber on the side of the radiation tube and a second chamber on the side of the inlet port. An air bubble chamber provided at an upper portion of the second chamber collects air bubbles formed in the coolant. A protrusion projecting toward the second chamber is provided at an end of the partition plate on the side of the opening. Since the air bubbles are moved due to buoyancy force or inertial force when the apparatus is rotated, it is possible to prevent radiation from passing through the air bubbles.

### BACKGROUND OF THE INVENTION

1. Field of the Invention

The present invention relates to a radiation generating apparatus which includes a radiation tube disposed in an envelope filled with coolant. Radiation generated in the radiation tube is extracted out of the envelope. The present invention relates also to a radiographic apparatus in which the radiation generating apparatus is used.

2. Description of the Related Art

In a radiation generating apparatus, radiation is generated by causing a target to be irradiated with electrons emitted by an electron source. A recently proposed radiation generating apparatus includes, a radiation tube contained within an outer casing (herein “envelope”); inside the radiation tube an electron source and a target are disposed. A thermionic source, such as a filament, is used as the electron source. Some thermionic sources, such as an impregnated hot cathode electron emitting element used as an electron source for cathode-ray tube, are small in size. In a radiation tube in which a thermionic source is used, part of the electron beam of thermoelectrons emitted from the thermionic source heated to high temperature is accelerated to high energy via a Wehnelt electrode, an extraction electrode, an accelerating electrode and a lens electrode. At the same time, after forming the electron beam into a desired shape, the target made of metal, such as tungsten, is irradiated with the electron beam of desired shape to cause radiation to be generated.

In order to generate radiation suitable for radiography, it is necessary to apply high voltage in the range of 40 kV to 150 kV between the electron source which is the cathode inside the radiation tube and the target, and to cause the target to be irradiated with the electron beam which has been accelerated to high energy. However, radiation generation efficiency at the time of generation of the radiation is as low as equal to or lower than 1%. In other words, most of the radiative energy is converted into thermal energy (heat). The generated heat may raise the temperature of the target and may cause heat damage of the target. If the target is damaged, it becomes impossible to generate the amount of radiation necessary for radiography. Therefore, it is necessary to prevent heat damage of the target. An exemplary method to prevent heat damage of the target is to fill the inside of the envelope with coolant and cause the coolant to circulate between the envelope and a heat exchanger which is connected to the envelope so as to cool the radiation tube.

In an apparatus for computerized transverse axial tomography and for portable X-ray equipment, for example, if air bubbles enter the coolant (e.g., insulation oil), the air bubbles in the coolant may move when the inclination or direction of the apparatus or the equipment change. Therefore, there is a possibility that radiation passes through the air bubbles. The X-ray which has passed through both the air bubbles and the coolant and is extracted outside the envelope differs in characteristic from the X-ray which has passed through only the coolant and is extracted outside the envelope. Therefore, there is a problem that, if the X-ray which has passed through the air bubbles is extracted, intensity of the X-ray flux is varied, whereby the quality of an X-ray image deteriorates.

Japanese Patent Application Laid-Open No. 2000-262509 discloses a technique to trap air bubbles which have entered the coolant circulating through between an X-ray tube vessel used for computerized transverse axial tomography and a heat exchanger connected to the X-ray tube vessel in an air bubble pocket provided at the X-ray tube vessel. In the disclosed configuration, a guide plate provided between an inlet port of the coolant inside the X-ray tube vessel and the X-ray tube guides the air bubbles which entered the coolant to an upper air bubble pocket provided at an upper portion of the X-ray tube vessel and to a lower air bubble pocket provided at a lower portion of the X-ray tube vessel. These air bubble pockets may collect the air bubbles only in the buoyancy force direction when the X-ray equipment is rotated and inclination of the X-ray equipment is changed. However, since the disclosed configuration is not equipped with a function to stop movement of the air bubbles due to inertial force when the inclination of the apparatus is being changed, there is a possibility that the air bubbles escape from, for example, the lower air bubble pocket, when the apparatus is at a certain rotated angle. Further, the guide plate has no function to stop movement of the air bubbles due to inertial force when the inclination of the apparatus is being changed. Therefore, there has been a problem that the air bubbles which have escaped from, for example, the lower air bubble pocket move toward the X-ray tube and the X-ray passes through the air bubbles, whereby uniformity of the X-ray flux is reduced and the X-ray image is adversely affected. As a result, image quality is reduced.

The various exemplary embodiments of present invention disclose a radiation generating apparatus in which movement due to inertial force of air bubbles, which have entered the coolant, is prevented when the apparatus is rotated. Thus the passing of radiation through air bubbles is advantageously prevented. One embodiment of the present invention also describes a radiographic apparatus in which the radiation generating apparatus is used.

### SUMMARY OF THE INVENTION

A radiation generating apparatus, in accordance with the present invention, includes: an envelope; a radiation tube disposed inside the envelope; coolant disposed between the envelope and the radiation tube; and a cooler connected to the envelope at an inlet port and an outlet port provided at a bottom portion of the envelope, wherein: the coolant in the envelope is made to circulate through between the envelope and the cooler by being delivered to the cooler through the outlet port and then delivered, after being cooled in the cooler, to the envelope through the inlet port; a partition plate which divides the inside of the envelope into a first chamber on the side of the radiation tube and a second chamber on the side of the inlet port is provided to extend from a bottom portion to an upper portion of the envelope with an opening being left; an air bubble chamber in which air bubbles in the coolant are collected is provided at an upper portion of the second chamber; and a protrusion projecting toward the second chamber is provided at an end of the partition plate on the side of the opening.

A radiation generating apparatus, in accordance with the present invention, includes: an envelope; a radiation tube disposed inside the envelope; coolant disposed between the envelope and the radiation tube; and a cooler connected to the envelope at an inlet port and an outlet port provided at a bottom portion of the envelope, wherein: the coolant in the envelope is made to circulate through between the envelope and the cooler by being delivered to the cooler through the outlet port and then delivered, after being cooled in the cooler, to the envelope through the inlet port; a partition plate which divides the inside of the envelope into a first chamber on the side of the radiation tube and a second chamber on the side of the inlet port is provided to extend from an upper portion to a bottom portion of the envelope with an opening being left; and a protrusion projecting toward the second chamber is provided at an end of the partition plate on the side of the opening.

According to the present invention, a partition plate divides the inside of the envelope into a first chamber on the side of the radiation tube and a second chamber on the side of the inlet port of the coolant with an opening being left is provided. A protrusion projecting toward the inlet port is provided at an end of the partition plate on the side of the opening. The projection prevents the air bubbles from flowing into the first chamber due to inertial force when the apparatus is rotated. Therefore, it is possible to prevent the radiation from passing through the air bubbles. With this configuration, since a decrease in uniformity of radiation flux may be prevented, reduction in radiation image quality may be prevented.

Further features of the present invention will become apparent from the following description of exemplary embodiments with reference to the attached drawings.

### BRIEF DESCRIPTION OF THE DRAWINGS

FIGS. 1A, 1B and 1C are schematic sectional views illustrating preferred embodiments of a radiation generating apparatus according to embodiments of the present invention.

FIG. 2 is a schematic sectional view illustrating a condition of air bubbles when the radiation generating apparatus of FIG. 1A is rotated.

FIGS. 3A and 3B are schematic sectional views of a radiation generating apparatus of a second embodiment.

FIG. 4 is a schematic sectional view illustrating a condition of air bubbles when the radiation generating apparatus of FIG. 3A is rotated.

FIGS. 5A and 5B are schematic sectional views of radiation generating apparatus of a third embodiment.

FIG. 6 is a schematic sectional view illustrating a condition of air bubbles when the radiation generating apparatus of FIG. 5A is rotated.

FIG. 7 is a diagram illustrating an exemplary radiographic apparatus in which the radiation generating apparatus in accordance with an embodiment of the present invention is used.

### DESCRIPTION OF THE EMBODIMENTS

Hereinafter, specific embodiments of radiation generating apparatus and radiographic apparatus of the present invention will be described.

### First Embodiment

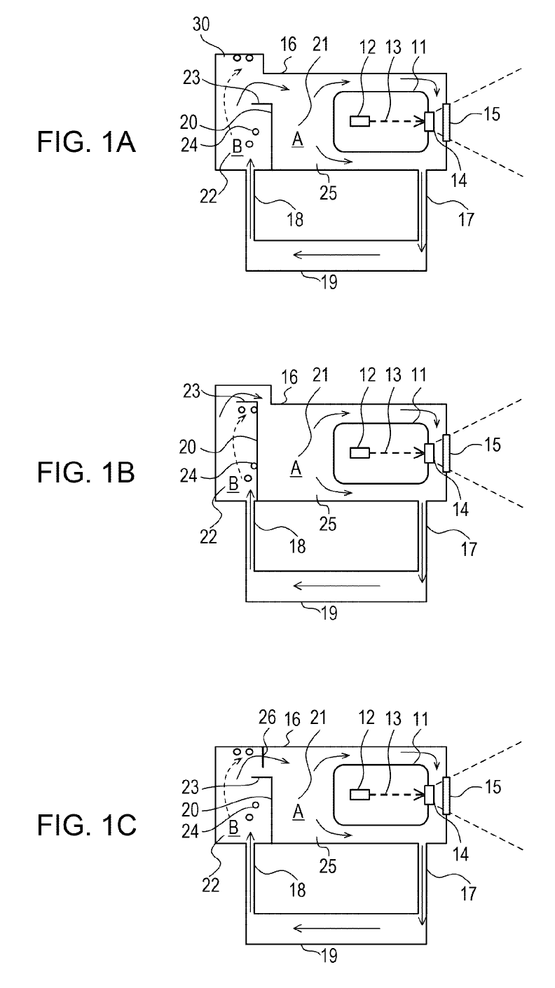

FIG. 1A is a schematic sectional view of the radiation generating apparatus of the present embodiment. A lower direction of the schematic diagram corresponds to the gravity direction.

The radiation generating apparatus of the present embodiment includes a radiation tube 11 (herein, a transmission radiation tube). The radiation tube 11 is a cylindrically-shaped airtight vessel which is closed at both ends. An electron source 12 is disposed inside the cylindrical portion of the radiation tube 11. A target 14 is provided at an end of the radiation tube 11 so as to face the electron source 12. An electron beam 13 is emitted from the electron source 12 in the direction of the target 14. The diameter of the electron beam 13 is adjusted into a necessary diameter before the target 14 is irradiated with the electron beam 13. Then, the radiation is emitted from the target 14. The target 14 functions also as a radiation extraction window through which radiation generated by the radiation tube 11 is extracted.

When radiography for, for example, a human patient is to be performed, the electrical potential of the target 14 is set higher than the electrical potential of the electron source 12 by about +30 kV to 150 kV. This potential difference is an acceleration potential difference necessary for the radiation emitted from the target 14 to pass through the human patient and effectively contribute the radiography. Radiation generated here is mainly X-ray.

A power circuit (not illustrated) is connected to the radiation tube 11 (by wiring which is not illustrated) for supplying the electron source 12 and the target 14 with electricity. Although the power circuit is disposed outside an envelope 16 in the present embodiment, the power circuit may be disposed inside the envelope 16.

In order to keep the degree of vacuum inside the radiation tube 11 at equal to or lower than 1×10⁻⁴ Pa at which the electron source 12 can be generally driven, a barium getter, a non-evaporable getter (NEG) module, a small ion pump (not illustrated) or other devices for absorbing gas emitted from the radiation tube 11 while the radiation tube 11 is being driven may be disposed inside the radiation tube 11. The radiation tube 11 is desirably made of a material which is excellent in electrical insulation, vacuum retention and heat resistance. For example, alumina and glass may be used. Examples of the electron source 12 include, but are not limited to, a filament, an impregnated cathode and a field emission element.

The target 14 is disposed so as to face the electron source 12. The target 14 is supported by a target substrate (not illustrated) from the side opposite to the electron source 12. The target 14 may be made of metal, such as tungsten, molybdenum and copper. The target substrate (not illustrated) may be made of a material which has high thermal conductivity and low radiation absorption. For example, SiC, diamond, carbon, thin-layered oxygen free copper and beryllium may be used.

The radiation tube 11 is disposed inside an outer casing or envelope 16. The envelop 16 includes an inlet port and an outlet port, and it may be made of a material which can hermetically seal a coolant material within its surfaces. A radiation extraction port 15 is provided in the envelope 16 at a position at which the envelope 16 faces the target 14. The radiation extraction port 15 is desirably made of a material of which the amount of radiation attenuation is relatively small. For example, an acrylic resin board, a polycarbonate board, an aluminum board, an epoxy resin board and a polyimide board may be used. With such materials, greater radiation may be obtained. For example, a 3-mm thick epoxy resin board is disposed as the radiation extraction port 15.

A space between the envelope 16 and the radiation tube 11 is filled with coolant 25. If the radiation tube 11 is contained in a vessel which is cooled by coolant, such as insulation oil, and is insulated from the coolant, the coolant 25 may be water. If the coolant 25 is used for electric insulation between the radiation tube 11 and the envelope 16, the coolant 25 desirably has high electrical insulation capacity and cooling capacity. Since the target 14 is heated to high temperature and the heat is transmitted to the coolant 25, it is desirable that the coolant 25 is not easily modified by heat. For example, the coolant 25 may be electric insulating oil and fluorine-based insulating liquid.

The envelope 16 is connected to a cooler 19 which cools the coolant 25. The envelope 16 is connected to the cooler 19 at an inlet port and an outlet port provided at the envelope 16. A periphery of the radiation tube 11 is formed as a flow path of the coolant 25 and the coolant 25 circulates through between the envelope 16 and the cooler 19. In the present embodiment, the outlet port provided at a bottom portion of the envelope 16 and the cooler 19 are connected to each other via a coolant flow path 17, and the inlet port provided at the bottom portion of the envelope 16 and the cooler 19 are connected to each other via a coolant flow path 18. The coolant flow path 17 is a coolant discharge path through which the coolant 25 in the envelope is delivered to the cooler 19. The coolant flow path 18 is a refrigerant introducing path through which the coolant 25 cooled in the cooler 19 is delivered from the cooler 19 to the envelope 16.

A partition plate 20 is disposed inside the envelope 16. The inside of the envelope is divided into two chambers: a chamber A 21 on the side of the radiation tube (“first chamber”) and a chamber B 22 on the side of the inlet port of the envelope 16 (“second chamber”). The partition plate 20 is provided to extend upward from the bottom portion of the envelope 16. The chamber A 21 and the chamber B 22 communicate with each other through an opening (hereinafter, referred to as a “communication port”). A protrusion 23 projecting toward the chamber B 22 is provided at an end of the partition plate 20 on the side of the opening (i.e., on the side of the communication port).

In FIG. 1A, an air bubble chamber 30 is provided at an upper portion of the chamber B 22. Air bubbles 24 in the coolant flowing mainly through the inlet port of the envelope 16 can float either by buoyancy or inertia and are collected in the air bubble chamber 30. The air bubble chamber 30 can be defined by making at least a portion of the upper portion of the envelope 16 on the side of the chamber B 22 protrude outward.

During active operation, while the radiation generating apparatus is being driven, the heat generated in the target 14 of the chamber A 21 is absorbed by the coolant 25. The coolant 25 is delivered to the cooler 19 via the coolant flow path 17, cooled by the cooler 19 and then delivered to the chamber B 22 of the envelope 16 via the coolant flow path 18 by a pump (not illustrated) which is attached to the cooler 19. The coolant 25 delivered to the chamber B 22 is then delivered to the chamber A 21 through the communication port and circulates.

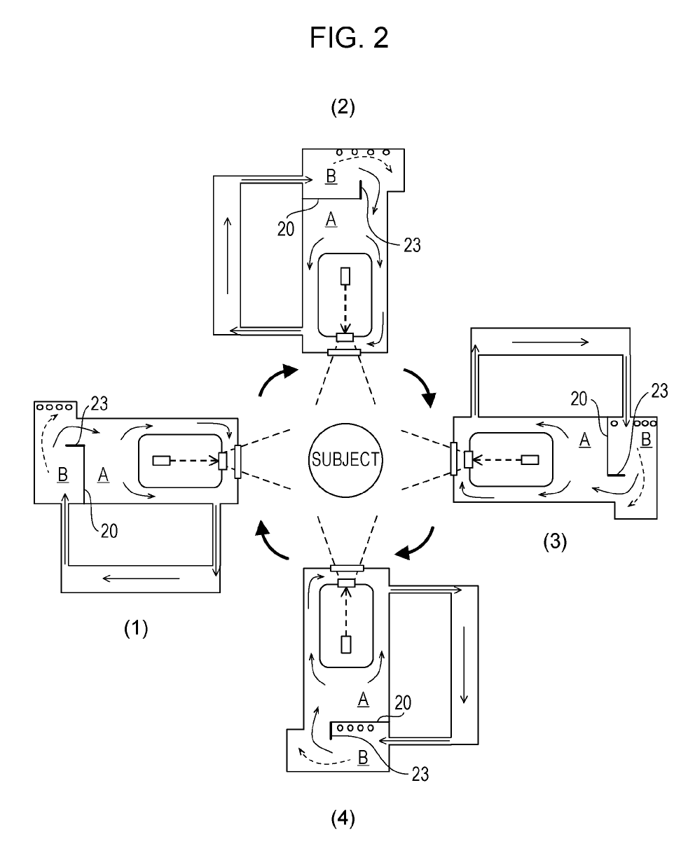

In the radiation generating apparatus having the above-described configuration, air bubbles may enter the coolant 25. The air bubbles enter the coolant 25 from, for example, a joint portion of the coolant flow path 18 and the inlet port of the envelope 16. In a case in which air bubbles 24 enter the coolant 25 of the radiation generating apparatus of FIG. 1A, a condition of the air bubbles when the radiation generating apparatus of FIG. 1A is rotated is illustrated in FIG. 2.

(1) of FIG. 2 illustrates a condition in which, after the air bubbles 24 enter the coolant 25 of the radiation generating apparatus of FIG. 1A, the air bubbles 24 are trapped in the air bubble chamber provided at the upper portion of the envelope 16 on the side of the chamber B 22 due to buoyancy force of the air bubbles 24 and circulation of the coolant 25. Since the air bubbles 24 are trapped in the air bubble chamber, the air bubbles 24 are not made to flow into the chamber A 21 through the communication port.

(2) of FIG. 2 illustrates a condition in which the radiation generating apparatus of FIG. 1A has been rotated 90 degrees in the same direction as the circulating direction of the coolant 25. Although the coolant 25 flows in through the inlet port of the envelope 16, buoyancy force of the air bubbles 24 causes the air bubbles 24 to move toward an end surface of the chamber B 22 on the side of the inlet port of the envelope 16 and, therefore, prevents the air bubbles 24 from flowing into the chamber A 21 through the communication port.

(3) of FIG. 2 illustrates a condition in which the radiation generating apparatus of FIG. 1A has been rotated 180 degrees in the same direction as the circulating direction of the coolant 25. Although the coolant 25 flows in through the inlet port of the envelope 16, buoyancy force of the air bubbles 24 causes the air bubbles 24 to move near the inlet port of the envelope 16 of the chamber B 22 and, therefore, prevents the air bubbles 24 from flowing into the chamber A 21 through the communication port.

(4) of FIG. 2 illustrates a condition in which the radiation generating apparatus of FIG. 1A has been rotated 270 degrees in the same direction as the circulating direction of the coolant 25. Buoyancy force of the air bubbles 24 causes the air bubbles 24 to move to a surface of the partition plate 20 on the side of the chamber B 22. Although the coolant 25 flows in through the inlet port of the envelope 16, the air bubbles 24 are dammed up by the protrusion 23 and, therefore, are not made to flow into the chamber A 21 through the communication port.

While the angle of inclination of the radiation generating apparatus is being changed, the protrusion 23 stops the movement due to inertial force of the air bubbles 24. Therefore, flowing of the air bubbles 24 into the chamber A 21 from the chamber B 22 may be prevented.

FIGS. 1B and 1C are schematic sectional views illustrating other examples of the radiation generating apparatus of the present embodiment. The lower section of the schematic diagram corresponds to the direction in which gravity acts on the radiation generating apparatus. That is, the lower section of the radiation generating apparatus corresponds to the gravity direction.

The radiation generating apparatus of FIG. 1B differs from the radiation generating apparatus of FIG. 1A in that the partition plate 20 is disposed at a position closer to the inlet port of the envelope 16, and in that the end of the partition plate 20 on the side of the communication port is extended to the inside of the air bubble chamber. In the radiation generating apparatus of FIG. 1B, since the communication port is narrower than that of the radiation generating apparatus of FIG. 1A, flowing of the air bubbles 24 into the chamber A 21 from the chamber B 22 may be prevented more reliably.

The radiation generating apparatus of FIG. 1C differs from the radiation generating apparatus of FIG. 1A in that the upper portion of the envelope 16 on the side of the chamber B 22 does not protrude outward and that the air bubble chamber is defined by a plate member 26 which is provided to extend from an upper portion of the envelope 16 to the bottom portion at a position further toward the chamber B 22 than the radiation tube 11. The radiation generating apparatus of FIG. 1C has the same effect as that of the radiation generating apparatus of FIG. 1A in preventing the flowing of the air bubbles 24 into the chamber A 21 from the chamber B 22.

As described above, according to the present embodiment, movement of the air bubbles 24 toward the radiation tube due to buoyancy force or inertial force and passing-through of the air bubbles by radiation may be prevented.

The radiation tube 11 may be a reflective radiation tube. The partition plate 20 may extend from the bottom portion to the upper portion of the envelope 16 in an inclined manner toward the chamber B.

### Second Embodiment

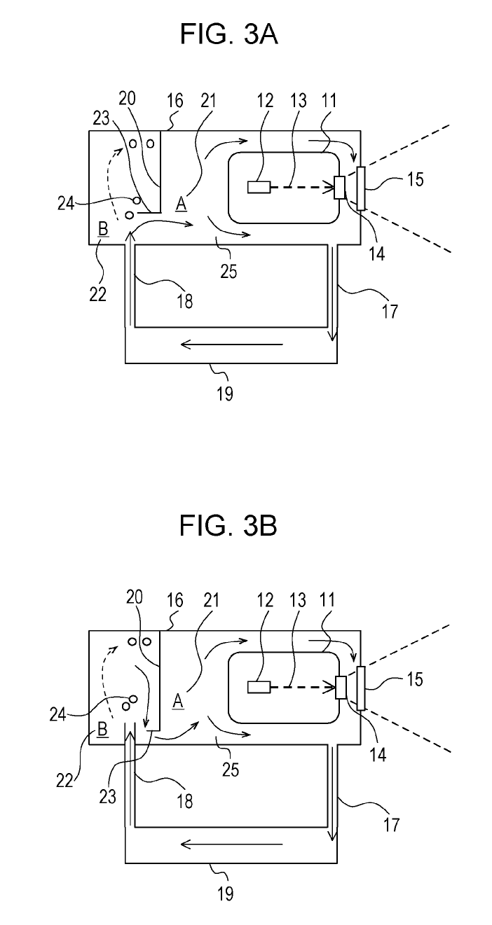

FIG. 3A is a schematic sectional view of the radiation generating apparatus of the present embodiment. A lower direction of the schematic diagram corresponds to the gravity direction.

The radiation generating apparatus of FIG. 3A differs from the first embodiment in that a partition plate 20 is provided to extend from an upper portion to a bottom portion of an envelope 16. A chamber A 21 and a chamber B 22 communicate with each other through a communication port. A protrusion 23 projecting to the side of the chamber B 22 is provided at an end of the partition plate 20 on the side of the communication port.

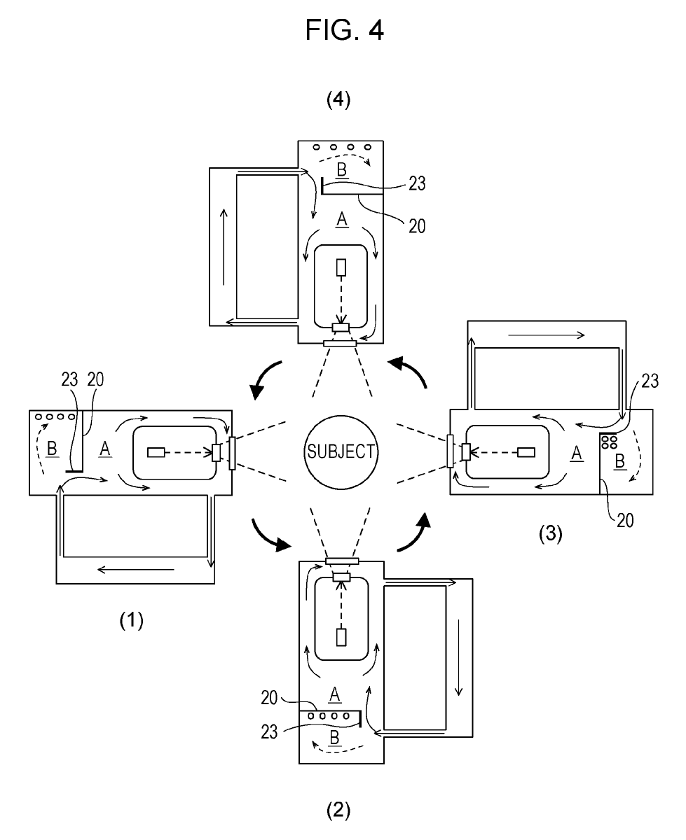

In a case in which air bubbles 24 enter coolant 25 of the radiation generating apparatus of FIG. 3A, a condition of the air bubbles 24 when the radiation generating apparatus of FIG. 3A is rotated is illustrated in FIG. 4.

(1) of FIG. 4 illustrates a condition in which, after the air bubbles 24 enters the coolant 25 of the radiation generating apparatus of FIG. 3A, the air bubbles 24 have moved to the upper portion of the envelope 16 on the side of the chamber B 22 due to buoyancy force of the air bubbles 24 and circulation of the coolant 25. Since the air bubbles 24 are dammed up by the partition plate 20, the air bubbles 24 are not made to flow into the chamber A 21 through the communication port.

(2) of FIG. 4 illustrates a condition in which the radiation generating apparatus of FIG. 3A has been rotated 90 degrees in the direction opposite to the circulating direction of the coolant 25. Buoyancy force of the air bubbles 24 causes the air bubbles 24 to move to a surface of the partition plate 20 on the side of the chamber B 22. Since the air bubbles 24 are dammed up by the protrusion 23, the air bubbles 24 are not made to flow into the chamber A 21 through the communication port.

(3) of FIG. 4 illustrates a condition in which the radiation generating apparatus of FIG. 3A has been rotated 180 degrees in the direction opposite to the circulating direction of the coolant 25. Although buoyancy force of the air bubbles 24 causes the air bubbles 24 to move toward the side of an inlet port of the envelope 16 of the chamber B 22, the air bubbles 24 are not made to reach an area near the inlet port where the coolant 25 flows fast and are dammed up by the protrusion 23. Therefore, the air bubbles 24 are not made to flow into the chamber A 21 through the communication port.

(4) of FIG. 4 illustrates a condition in which the radiation generating apparatus of FIG. 3A has been rotated 270 degrees in the direction opposite to the circulating direction of the coolant 25. Buoyancy force of the air bubbles 24 causes the air bubbles 24 to move toward an end surface of the chamber B 22 on the side of the inlet port of the envelope 16 and, therefore, prevents the air bubbles 24 from flowing into the chamber A 21 through the communication port.

While the angle of inclination of the radiation generating apparatus is being changed, the protrusion 23 stops the movement due to inertial force of the air bubbles 24. Therefore, flowing of the air bubbles 24 into the chamber A 21 from the chamber B 22 may be prevented.

Next, FIG. 3B is a schematic sectional view illustrating another example of the radiation generating apparatus of the present embodiment. A lower direction of the schematic diagram corresponds to the gravity direction.

The radiation generating apparatus of FIG. 3B differs from the radiation generating apparatus of FIG. 3A in that a coolant flow path 18 extends further upward than an end of the partition plate 20 at the side of the communication port and the protrusion 23 is situated at a position lower than the end of the coolant flow path 18. In the radiation generating apparatus of FIG. 3B, since the communication port is narrower than that of the radiation generating apparatus of FIG. 3A, flowing of the air bubbles 24 into the chamber A 21 from the chamber B 22 may be prevented more reliably.

A radiation tube 11 may be a reflective radiation tube. The partition plate 20 may extend from the upper portion to the bottom portion of the envelope 16 in an inclined manner toward the chamber B 22.

### Third Embodiment

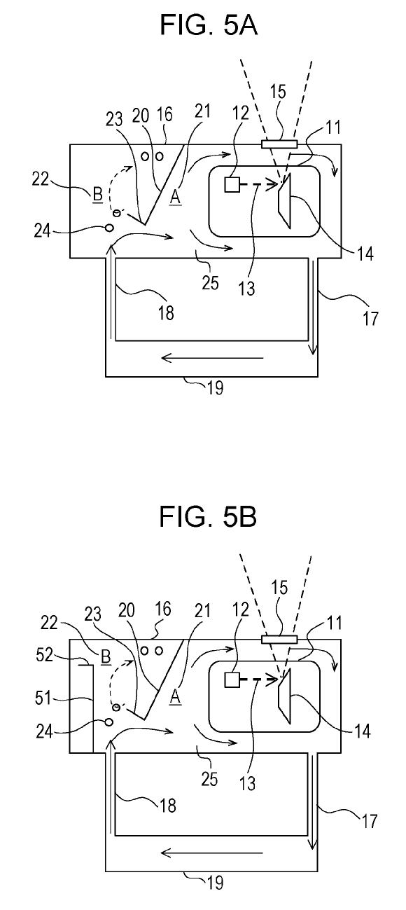

FIG. 5A is a schematic sectional view of the radiation generating apparatus of the present embodiment. A lower direction of the schematic diagram corresponds to the gravity direction.

The radiation generating apparatus of FIG. 5A differs from the second embodiment in that a radiation tube 11 is a reflective radiation tube and that a partition plate 20 is provided to extend from an upper portion to a bottom portion of an envelope 16 in an inclined manner. A chamber A 21 and a chamber B 22 communicate with each other through a communication port. A protrusion 23 projecting to the side of the chamber B 22 is provided at an end of the partition plate 20 on the side of the communication port.

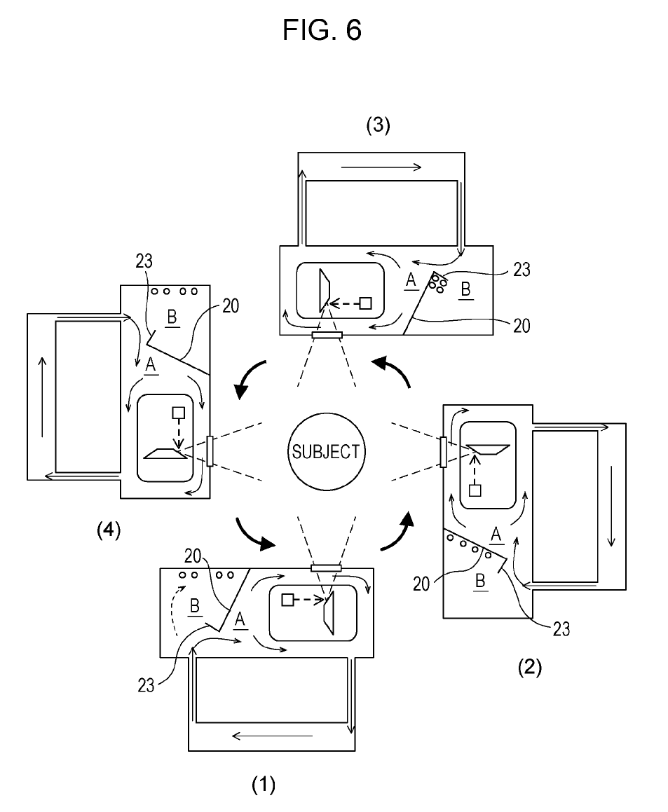

In a case in which air bubbles 24 enter coolant 25 of the radiation generating apparatus of FIG. 5A, a condition of the air bubbles 24 when the radiation generating apparatus of FIG. 5A is rotated is illustrated in FIG. 6.

(1) of FIG. 6 illustrates a condition in which, after the air bubbles 24 enters the coolant 25 of the radiation generating apparatus of FIG. 5A, the air bubbles 24 have moved to the upper portion of the envelope 16 on the side of the chamber B 22 due to buoyancy force of the air bubbles 24 and circulation of the coolant 25. Since the air bubbles 24 are dammed up by the partition plate 20, the air bubbles 24 are not made to flow into the chamber A 21 through the communication port.

(2) of FIG. 6 illustrates a condition in which the radiation generating apparatus of FIG. 5A has been rotated 90 degrees in the direction opposite to the circulating direction of the coolant 25. Buoyancy force of the air bubbles 24 causes the air bubbles 24 to move to a surface of the partition plate 20 on the side of the chamber B 22. Since the air bubbles 24 are dammed up by the protrusion 23, the air bubbles 24 are not made to flow into the chamber A 21 through the communication port.

(3) of FIG. 6 illustrates a condition in which the radiation generating apparatus of FIG. 5A has been rotated 180 degrees in the direction opposite to the circulating direction of the coolant 25. Although buoyancy force of the air bubbles 24 causes the air bubbles 24 to move toward the side of an inlet port of the envelope 16 of the chamber B 22, the air bubbles 24 are not made to reach an area near the inlet port where the coolant 25 flows fast and are dammed up by the protrusion 23. Therefore, the air bubbles 24 are not made to flow into the chamber A 21 through the communication port.

(4) of FIG. 6 illustrates a condition in which the radiation generating apparatus of FIG. 5A has been rotated 270 degrees in the direction opposite to the circulating direction of the coolant 25. Buoyancy force of the air bubbles 24 causes the air bubbles 24 to move toward an end surface of the chamber B 22 on the side of the inlet port of the envelope 16 and, therefore, prevents the air bubbles 24 from flowing into the chamber A 21 through the communication port.

While the angle of inclination of the radiation generating apparatus is being changed, the protrusion 23 stops the movement due to inertial force of the air bubbles 24. Therefore, flowing of the air bubbles 24 into the chamber A 21 from the chamber B 22 may be prevented.

FIG. 5B is a schematic sectional view illustrating another example of the radiation generating apparatus of the present embodiment. A lower direction of the schematic diagram corresponds to the gravity direction.

The radiation generating apparatus of FIG. 5B differs from the radiation generating apparatus of FIG. 5A in that a partition plate 51 which is separate from the partition plate 20 is provided in the chamber B 22 while keeping an opening and that a protrusion 52 is provided in the partition plate 51 at an end on the side of the opening. In the radiation generating apparatus of FIG. 5B, since the partition plate 51 is provided at a position at which the inlet port of the envelope 16 is disposed between the partition plate 51 and the partition plate 20 and since the protrusion 52 projects in the direction opposite to the inlet port of the envelope 16 at the end of the partition plate 51 on the side of the opening, the air bubbles 24 may be stopped in a dual stop mechanism. Therefore, it is possible to further prevent the air bubbles 24 from flowing into the chamber A 21 from the chamber B 22 more reliably.

The radiation tube 11 may be a transmission radiation tube.

### Fourth Embodiment

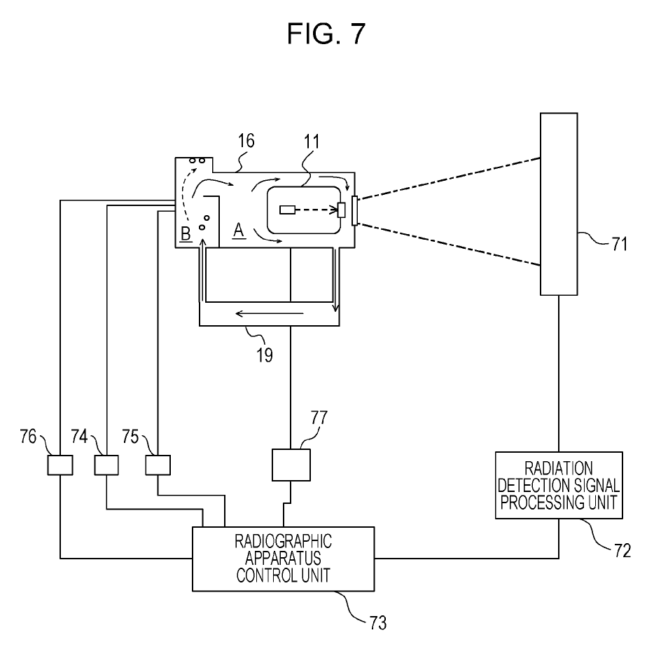

Radiographic apparatus in which the radiation generating apparatus of the present invention is used will be described with reference to FIG. 7. FIG. 7 is a configuration diagram of the radiographic apparatus of the present embodiment. The radiographic apparatus includes a radiation tube 11 (herein, a transmission radiation tube), a radiation detector 71, a radiation detection signal processing unit 72, a radiographic apparatus control unit 73, an electron source driving unit 74, an electron source heater control unit 75, a control electrode voltage control unit 76 and a target voltage control unit 77. As the radiation generating apparatus used in the radiographic apparatus of the present invention, the radiation generating apparatus of the first, second or third embodiment is desirable.

The radiation detector 71 is connected to the radiographic apparatus control unit 73 via the radiation detection signal processing unit 72. Output signals of the radiographic apparatus control unit 73 are connected to terminals of the radiation tube 11 via the electron source driving unit 74, the electron source heater control unit 75, the control electrode voltage control unit 76 and the target voltage control unit 77.

When radiation is generated in the radiation tube 11, the radiation emitted into the atmosphere is made to pass through a subject (not illustrated) and then detected by the radiation detector 71. Then, a radiation image formed by the radiation having passed through the subject is obtained. The obtained radiation image may be displayed on a display unit (not illustrated).

From the foregoing description, according to the present embodiment, since the radiation generating apparatus which produces the effect of the first, second or third embodiment is used, radiographic apparatus that is capable of generating radiation stably for a long time and is therefore highly reliable may be implemented.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-006953 filed Jan. 17, 2012, which is hereby incorporated by reference herein in its entirety.

What is claimed is:

1. A radiation generating apparatus comprising:
an envelope;
a radiation tube disposed inside the envelope;
coolant disposed between the envelope and the radiation tube; and
a cooler connected to the envelope at an inlet port and an outlet port provided at a bottom portion of the envelope,
wherein:
the coolant in the envelope is made to circulate through between the envelope and the cooler by being delivered to the cooler through the outlet port and then delivered, after being cooled in the cooler, to the envelope through the inlet port;
a partition plate which divides the inside of the envelope into a first chamber on the side of the radiation tube and a second chamber on the side of the inlet port is provided to extend from a bottom portion to an upper portion of the envelope with an opening being left;
an air bubble chamber in which air bubbles in the coolant are collected is provided at an upper portion of the second chamber; and
a protrusion projecting toward the second chamber is provided at an end of the partition plate on the side of the opening.

2. The radiation generating apparatus according to claim 1, wherein the air bubble chamber is formed by making at least a portion of the upper portion of the envelope on the side of the second chamber protrude outward.

3. The radiation generating apparatus according to claim 1, wherein the air bubble chamber is defined by a plate member provided to extend from an upper portion to a bottom portion of the envelope at a position further toward the second chamber than the radiation tube.

4. The radiation generating apparatus according to claim 1, wherein the partition plate extends from the bottom portion to the upper portion of the envelope in an inclined manner toward the second chamber.

5. A radiation generating apparatus comprising:
an envelope;
a radiation tube disposed inside the envelope;
coolant disposed between the envelope and the radiation tube; and
a cooler connected to the envelope at an inlet port and an outlet port provided at a bottom portion of the envelope,
wherein:
the coolant in the envelope is made to circulate through between the envelope and the cooler by being delivered to the cooler through the outlet port and then delivered, after being cooled in the cooler, to the envelope through the inlet port;
a partition plate which divides the inside of the envelope into a first chamber on the side of the radiation tube and a second chamber on the side of the inlet port is provided to extend from an upper portion to a bottom portion of the envelope with an opening being left; and
a protrusion projecting toward the second chamber is provided at an end of the partition plate on the side of the opening.

6. The radiation generating apparatus according to claim 5, wherein the partition plate extends from the upper portion to the bottom portion of the envelope in an inclined manner toward the second chamber.

7. The radiation generating apparatus according to claim 1, wherein the radiation tube is a transmission radiation tube.

8. The radiation generating apparatus according to claim 5, wherein the radiation tube is a reflective radiation tube.

9. A radiographic apparatus comprising:
a radiation generating apparatus which includes:
an envelope;
a radiation tube disposed inside the envelope;
coolant disposed between the envelope and the radiation tube; and
a cooler connected to the envelope at an inlet port and an outlet port provided at a bottom portion of the envelope,
wherein:
the coolant in the envelope is made to circulate through between the envelope and the cooler by being delivered to the cooler through the outlet port and then delivered, after being cooled in the cooler, to the envelope through the inlet port;
a partition plate which divides the inside of the envelope into a first chamber on the side of the radiation tube and a second chamber on the side of the inlet port is provided to extend from a bottom portion to an upper portion of the envelope with an opening being left;
an air bubble chamber in which air bubbles in the coolant are collected is provided at an upper portion of the second chamber; and
a protrusion projecting toward the second chamber is provided at an end of the partition plate on the side of the opening;
a radiation detector for detecting radiation emitted from the radiation generating apparatus and passed through a subject; and
controller for controlling the radiation generating apparatus and the radiation detector.

10. A radiation generating apparatus comprising:
an envelope having an inlet port and an outlet port;
a radiation tube disposed inside the envelope;
a partition plate which divides the inside of the envelope into a first chamber and a second chamber, first chamber containing the radiation tube and connecting with the second chamber via a communication port; and
a cooler connected to the first chamber via the outlet port and to the second chamber via the inlet port,
wherein a coolant circulating path is formed between the envelop and the cooler so that coolant in the envelope is made to circulate through the envelope and the cooler by being delivered to the cooler through the outlet port and then delivered, after being cooled in the cooler, to the envelope through the inlet port,
wherein an air bubble chamber in which air bubbles in the coolant are collected is provided at an upper portion of the second chamber, and
wherein a protrusion projecting toward the second chamber is provided at an end of the partition plate on the side of the opening.
